(19) United States
(12) Patent Application Publication
(10) Pub. No.: US 2004/0108000 A1
(43) Pub. Date: Jun. 10, 2004

(54) Ultrahigh-pressure check valve

(75) Inventors: Chidambaram Raghavan, Kent, WA (US); Olivier L. Tremoulet JR., Edmonds, WA (US); Katherine M. Madden, Kent, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Flow International Corporation, Kent, WA

(21) Appl. No.: 10/313,891

(22) Filed: Dec. 6, 2002

(51) Int. Cl. F16K 15/00

(52) U.S. Cl. 137/540

(57) ABSTRACT

A check valve for use in a high-pressure pump is provided with a check valve seat having a frustoconical end region that engages a tapered surface provided on an outlet adaptor. By providing a conical interface between the check valve seat and the outlet adaptor, a compressive stress is placed on the valve seat, thereby dramatically increasing the fatigue life of the check valve.

### BACKGROUND OF THE INVENTION

1. Field of the Invention

The present invention relates to check valves for use in high-pressure applications, and more particularly, to check valves for use in ultrahigh-pressure pumps.

2. Description of the Related Art

High-pressure intensifier pumps draw a volume of fluid into the pump on an intake stroke of a plunger, and on a pressure stroke of the plunger, pressurize the volume of fluid to a desired pressure, up to and beyond 87,000 psi. The pressurized fluid flows through a check valve body to an outlet check valve. If the pressure of the fluid is greater than a biasing force provided by high-pressure fluid in an outlet area acting on a downstream end of the outlet check valve, the high-pressure fluid overcomes the biasing force, and passes through the outlet check valve to the outlet area. Typically, a pump has multiple cylinders, and pressurized fluid from the outlet area of each pump is collected in an accumulator. High-pressure fluid collected in this manner is then selectively used to perform a desired function, such as cutting or cleaning. Such intensifiers are manufactured, for example, by the assignee of the present invention, Flow International Corporation of Kent, Wash.

Applicants believe it would be desirable for many applications to operate intensifiers at higher pressures than can be achieved reliably at the present time. For example, when outlet check valves are subjected to high pressures, up to and beyond 87,000 psi, a problem exists in that conventional check valve seats have a relatively short fatigue life, and fail at undesirably short intervals, causing downtime of the machine and lost productivity. Therefore, a need exists for an improved check valve, and in particular a check valve seat, that can withstand the fatigue cycles experienced in the operation of a high-pressure fluid pump. The present invention meets this need.

### BRIEF SUMMARY OF THE INVENTION

Conventional check valve seats for use in high-pressure applications, such as high-pressure fluid pumps, are substantially rectangular in cross-section. As discussed above, the valve seat is subjected to a fatigue cycle on every stroke of the intensifier plunger. By way of example, at 87,000 psi, conventional seats fail anywhere from after 10 hours of operation to 150 hours of operation. This range of fatigue life is unacceptable, and lacks the certainty and reliability desired when operating such equipment.

In accordance with the present invention, a check valve is provided, wherein the check valve seat has a first end region that is frustoconical in shape. The valve seat is positioned within an outlet check valve body, and a bore extending through the check valve seat aligns with a longitudinal passageway of the check valve body, thereby allowing pressurized fluid to flow through the check valve body and seat. An outlet adaptor that mates with the check valve body is provided with an annular tapered surface that engages the frustoconical outer surface of the check valve seat, thereby securing the check valve seat within the check valve body. A poppet provided within the outlet adaptor is seated against an end surface of the check valve seat. The poppet is biased against the end surface of the check valve seat by a spring and external pressure in an outlet area downstream of the outlet check valve acting on the poppet. The poppet is provided with a passageway that allows pressurized fluid to flow through the poppet to the outlet area when the pressure of the fluid flowing through the passageways of the check valve body and check valve seat is sufficient to overcome the biasing force on the poppet.

By providing a frustoconical end region on the check valve seat, and a tapered mating surface on the outlet adaptor, the outlet adaptor exerts a load across the conical surface of the check valve seat, resulting in a compressive stress field in the bore or passageway of the check valve seat. As a result, a check valve provided in accordance with the present invention provides reliable operation in the range of 450 hours or more, even when operated at high pressures of over 80,000 psi.

### BRIEF DESCRIPTION OF THE SEVERAL VIEWS OF THE DRAWING(S)

FIG. 1 is a partial cross-sectional plan view of a prior art check valve.

FIG. 2 is a partial cross-sectional plan view of a check valve provided in accordance with the present invention, shown installed in a high-pressure fluid pump.

FIG. 3 is a partial cross-sectional plan view of the check valve illustrated in FIG. 2, with the valve seat shown exploded from the outlet adaptor.

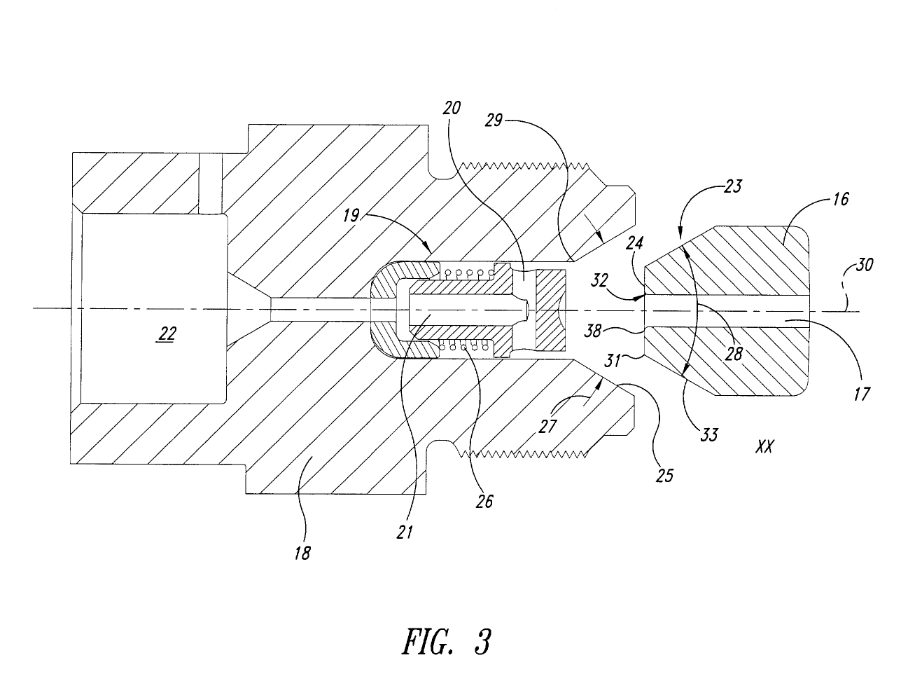

### DETAILED DESCRIPTION OF THE INVENTION

Briefly, the present invention provides an improved check valve that is able to better withstand the fatigue cycles experienced when used in a high-pressure environment, such as high-pressure fluid pumps. It will be understood that while the present invention is illustrated in a high-pressure fluid pump manufactured by Flow International Corporation, the check valve of the present invention may be used in any high-pressure fluid pump.

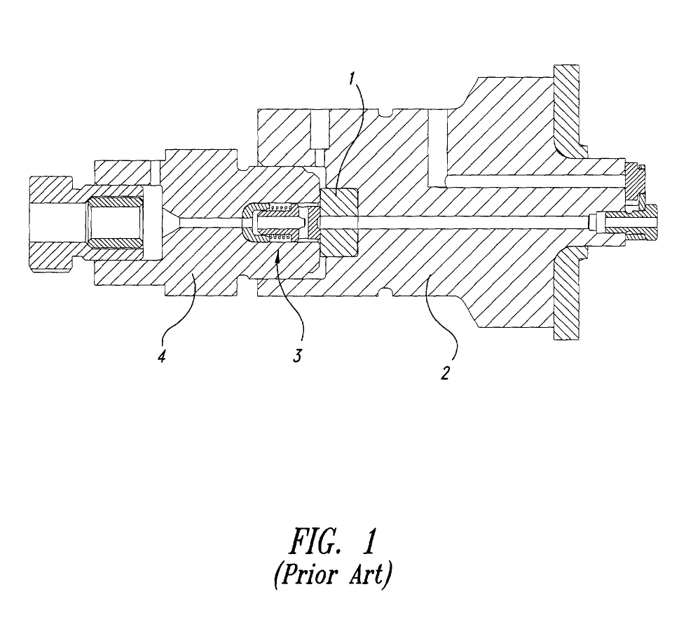

A prior art check valve is illustrated in FIG. 1. The surrounding elements of the high-pressure pump are well known to those of ordinary skill in the art and have been eliminated for simplicity. As seen in FIG. 1, a conventional check valve is provided with a valve seat 1 having a substantially rectangular cross-section. The valve seat 1 is held in position within the check valve body 2 via an outlet adaptor 4 that engages the check valve body 2 and acts against the valve seat 1 along a planar interface. A poppet 3 provided in the outlet adaptor 4 seats against the same planar surface of the substantially rectangular valve seat 1 as the outlet adaptor 4.

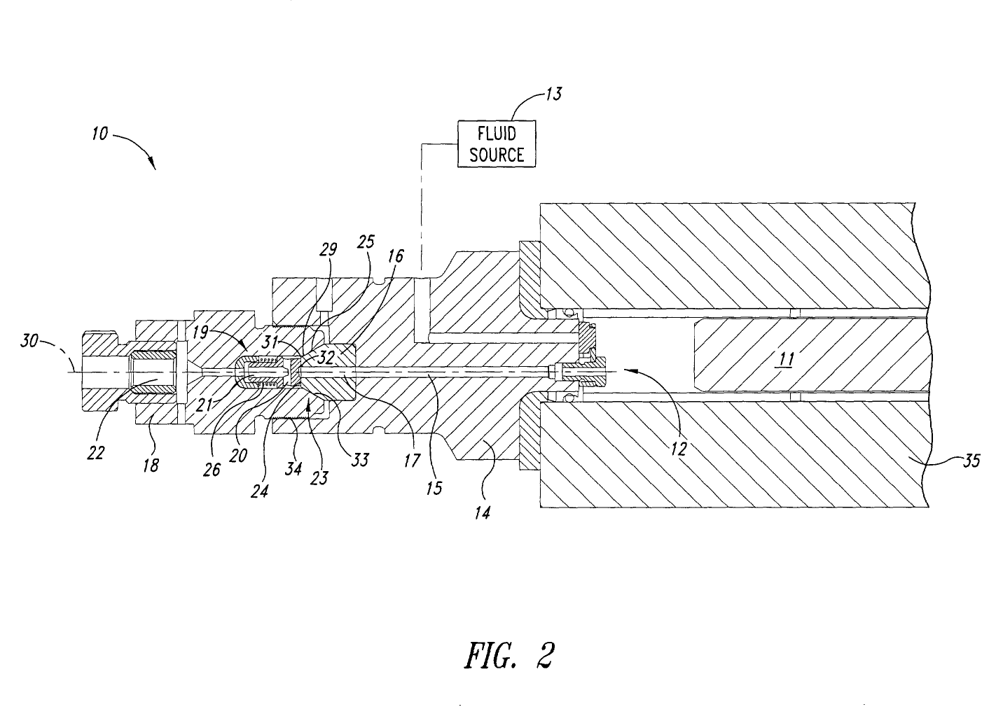

In accordance with the present invention, as illustrated in FIG. 2, a check valve is provided with a check valve seat 16 having a first end region 23 that is frustoconical. The frustoconical end region defines an annular tapered surface 33 and a substantially planar end face 24. The check valve seat 16 is held in a desired location within a check valve body 14 via an outlet adaptor 18 that engages the check valve body 14, for example via threads 34. The outlet adaptor 18 is provided with a tapered surface 25 that engages the outer surface 33 of the check valve seat 16. A poppet 19 provided within the outlet adaptor 18 is seated against the end face 24 of the check valve seat 16. Although the poppet 19 may be biased toward the check valve seat in any available way, in one embodiment, a spring 26 provides a biasing force to the poppet.

As discussed previously, the high-pressure pump 10 couples the check valve body 14 to a pump housing 35 in which a plunger 11 reciprocates. As the plunger 11 moves to the right in FIG. 2 on an intake stroke, a volume of fluid is drawn from a source of fluid 13 through an inlet check valve 12. On the pressure stroke of plunger 11, the fluid is pressurized and is forced into a longitudinal passageway 15 that extends through the check valve body 14. The check valve seat 16 is provided with a bore or second passageway 17 aligned with the first passageway 15, such that pressurized fluid flows through the check valve body and check valve seat. If the pressure of the fluid acting against the poppet 19 is sufficient, poppet 19 moves away from the end surface 24 of the check valve seat 16, and high-pressure fluid flows through port 20 and passageway 21 of the poppet to a high-pressure outlet region 22. High-pressure fluid then flows from outlet region 22 to an accumulator (not shown) to then be discharged and used in any desired manner.

When the plunger strokes back on an intake stroke, the spring 26 causes the poppet to close. The pressure in the passageway 15 drops to a low value, namely the charge pressure of the inlet. A pressure stroke and intake stroke of the intensifier plunger completes a cycle. From the foregoing, it will be appreciated that for each cycle, the passageway 15 and bore 17, particularly the inner comer or annular edge 32 of bore 17, are subjected to an alternating stress field.

By providing a check valve seat 16 with a frustoconical end region 23 and a corresponding tapered surface 25 on the outlet adaptor 18, the outlet adaptor exerts a load across this conical interface, resulting in a compressive stress field within the bore 17 of the check valve seat 16. In addition, the pressure from the outlet area 22 acting on the outer conical surface of the seat enhances this effect. By providing an improved check valve in accordance with the present invention, reliability and fatigue life is increased dramatically. Where conventional check valve seats operating at high pressures, such as 87,000 psi, may fail in as little as 10 hours, a check valve provided in accordance with the present invention may last upwards of 450 hours or more at the same pressure.

In one embodiment, an included angle 27 of the tapered surface 25 of outlet adaptor 18 is larger than the angle 28 formed by the frustoconical end region 23 of check valve seat 16. Although the difference in angles may vary, in one embodiment, the angle 27 of the outlet adaptor varies from the angle 28 of the check valve seat 16 by about 2 degrees. Also, while the frustoconical end region of the valve seat body may be provided at different angles, in one embodiment, the frustoconical end region forms an included angle of about 45-75 degrees, and more preferably, about 60 degrees. Again, regardless of the angle selected for the frustoconical region of the valve seat body, the corresponding angle of the outlet adaptor 18 is selected to differ by about 2 degrees.

Also, in one embodiment of the invention, an innermost annular edge 29 of the tapered surface 25 of outlet adaptor 18, relative to a longitudinal axis 30, contacts the frustoconical end region 23 of the valve seat 16 at a point removed from a bottom edge 31 of the frustoconical end region. Applicants believe it is desirable to expose this portion of the valve seat 16 to pressure on an outside diameter to help provide a compressive stress on the part. Applicants therefore believe that it is preferable to have the point of sealing between the adaptor 18 and the seat 16 be upstream of the bottom edge 31 of the valve seat.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A check valve comprising:
a valve seat positioned within a check valve body, the valve seat having a first frustoconical end region that mates against a tapered surface of an outlet adaptor, the outlet adaptor engaging the check valve body; and
a poppet positioned within the outlet adaptor and being biasable against an end surface of the valve seat.

2. The check valve according to claim 1 wherein an included angle of the tapered surface of the outlet adaptor is larger than the angle formed by the frustoconical end region of the valve seat.

3. The check valve according to claim 2 wherein the included angle of the tapered surface differs from the angle formed by the frustoconical end region by about 2 degrees.

4. The check valve according to claim 1 wherein the frustoconical end region of the valve seat forms an included angle of about 45-75 degrees.

5. The check valve according to claim 1 wherein an innermost annular edge of the tapered surface of the outlet adaptor relative to a longitudinal axis of the outlet adaptor contacts the frustoconical end region of the valve seat at a point removed from a bottom edge of the frustoconical end region.

6. A high-pressure check valve for use in a high-pressure pump comprising:
a poppet that is biasable in a first direction when installed in a high-pressure pump, the poppet being seated against a valve seat when biased in the first direction, the valve seat having a first end region adjacent the poppet that is frustoconical.

7. The high-pressure check valve according to claim 6 further comprising:
an outlet adaptor having a tapered surface that engages the frustoconical end region of the valve seat when installed in a high-pressure pump.

8. A high-pressure check valve for use in a high-pressure pump comprising:
a valve seat having a frustoconical end region and an outlet adaptor having a tapered surface that engages the frustoconical end region of the valve seat when installed in a high-pressure pump.

9. The high-pressure check valve according to claim 8 wherein an included angle of the tapered surface of the outlet adaptor is larger than the angle formed by the frustoconical end region of the valve seat.

10. The high-pressure check valve according to claim 9 wherein the included angle of the tapered surface differs from the angle formed by the frustoconical end region by about 2 degrees.

11. The high-pressure check valve according to claim 8 wherein the frustoconical end region of the valve seat forms an included angle of about 45-75 degrees.

12. The high-pressure check valve according to claim 8 wherein an innermost annular edge of the tapered surface of the outlet adaptor relative to a longitudinal axis of the outlet adaptor contacts the frustoconical end region of the valve seat at a point removed from a bottom edge of the frustoconical end region.

13. A valve seat for use in a high-pressure fluid pump comprising:
a body having a first region that is frustoconical to define an annular tapered surface and a first end face, the annular tapered surface engaging an outlet adaptor of a high-pressure pump and the first end face selectively engaging a high-pressure poppet, when the valve seat is positioned within a high-pressure fluid pump.

14. A high-pressure pump comprising:
a check valve body coupleable to a source of high-pressure fluid, a longitudinal passageway extending through the check valve body to allow high-pressure fluid to flow through the check valve body;
a check valve seat positioned within the check valve body, the check valve seat having a longitudinal bore that aligns with the longitudinal passageway of the check valve body, a distal end of the check valve seat having a frustoconical outer surface;
an outlet adaptor engaging the check valve body and having a tapered surface that engages the frustoconical outer surface of the check valve seat to secure the check valve seat in the check valve body; and
a poppet provided in the outlet adaptor, the poppet being seated against the check valve seat.

15. The high-pressure pump according to claim 14 wherein an included angle of the tapered surface of the outlet adaptor is larger than the angle formed by the frustoconical outer surface of the check valve seat.

16. The high-pressure pump according to claim 15 wherein the included angle of the tapered surface differs from the angle formed by the frustoconical outer surface by about 2 degrees.

17. The high-pressure pump according to claim 14 wherein the frustoconical outer surface of the check valve seat forms an included angle of about 45-75 degrees.

18. The high-pressure pump according to claim 14 wherein an innermost annular edge of the tapered surface of the outlet adaptor relative to a longitudinal axis of the outlet adaptor contacts the frustoconical outer surface of the check valve seat at a point removed from a bottom edge of the frustoconical outer surface.
